(19) United States
(12) Patent Application Publication
(10) Pub. No.: US 2020/0175593 A1
(43) Pub. Date: Jun. 4, 2020

(54) Method For Constructing Size And Value Indices Of China's Stock Market

(71) Applicant: Shanghai Mingshi Investment Management Co., Ltd., Shanghai (CN)

(72) Inventors: Yu YUAN, Shanghai (CN); Jianan LIU, Shanghai (CN); Robert F. STAMBAUGH, Berwyn, PA (US)

(21) Appl. No.: 16/700,307

(22) Filed: Dec. 2, 2019

(30) Foreign Application Priority Data
Dec. 3, 2018 (CN) 2018114722001

(51) Int. Cl. G06Q 40/04; G06Q 30/02

(52) U.S. Cl. CPC G06Q 40/04; G06Q 30/0201

(57) ABSTRACT

The present invention discloses a method for constructing size and value indices of the China's stock market. This invention categorizes A-share stocks into nine indices based on size and value, guiding different market participants who have different needs. Meanwhile, our methodology dynamically adjusts the sample used in the indices, deletes the stocks whose ranks drop below the cut-offs, and keeps the indices up-to-date.

### CROSS-REFERENCE TO RELATED APPLICATION

This application claims the benefit and priority of Chinese Application No. 2018114722001, filed Dec. 3, 2018. The entire disclosure of the above application is incorporated herein by reference.

### FIELD

This invention proposes a method to evaluate China's A-share stocks. In particular, it innovates a construction methodology of size and value index in China's A share market.

### BACKGROUND

Currently, stock index products are scarce in China's market. The existing ones only track the overall market, and investors who have specialized needs can hardly find structured index products to benchmark to. This invention is driven by the current scarcity in index products and innovates methodology to develop diverse index products.

### SUMMARY

This invention overcomes several technical challenges and proposes a novel methodology to construct size and value indices for China's A-share market.

The detailed technical procedures are as follows:

The construction of China's size and value indices takes following steps to:

S1. Obtain individual stocks' daily closing price and A-share total shares outstanding and take the product of the two as the daily market value, sort the entire stock universe by individual stocks' market values on the last trading day in every month, then delete the stocks that belong to the smallest X (percent), and use the remaining sample as the stock universe for the following month;

S2. Further separate the remaining sample from S1 equally by their last month-end market values into three size terciles, small-size group (bottom 33%), medium-size group (middle 33%) and large-size group (top 33%);

S3. Independently separate the remaining sample from S1 equally by the inverses of their last month-end valuation ratios into three value terciles, value group (bottom 33%), mixed group (middle 33%), and growth group (top 33%);

S4. By using the intersection of the groups from S2 and S3, obtain nine A-share size and value indices as follows

| | | |
|---|---|---|
| Small value | Medium value | Large value |
| Small mixed | Medium mixed | Large mixed |
| Small growth | Medium growth | Large growth |

S5. Calculate individual stocks' cum-dividend returns using their closing prices and daily dividends, and then, calculate the return of each of the nine indices as follows:

Ret(Index)_{t-1,t}=ΣWeightᵢ×Ret(stock i)_{t-1,t},

where, Ret(Index)_{t-1,t} indicates the index return from t−1 to t, Weightᵢ indicates the weight of stock i in the index, Ret(stock i)_{t-1,t} indicates the cum-dividend return of stock i from t−1 to t, and t indicates the time point, and the cum-dividend return for stock i being calculated as:

$${Ret ( stock i )}_{t - 1 , t} = \frac{Close {Price}_{i , t} + {Dividend}_{i , t}}{Close {Price}_{i , t - 1}} ,$$

where Close Price_{i,t} and Close Price_{i,t-1} are the closing prices of stock i at time t and t−1, and Dividend_{i,t} is the dividends distributed from t−1 to t;

S6. For each index, set the level at a chosen starting point as the benchmark level, set the value of the benchmark level to be 1000, and then for any point in time t calculate the index level at that time as Levelₜ=1000×Ret(Index)_{0,t}, where Ret(Index)_{0,t} is the cumulative return of this index from the chosen starting point to the time of t, and the cumulative return is calculated as Π_{k=1, . . . t}Ret(stock i)_{k-1,k}, where Ret(stock i)_{k-1,k} is defined as in S5;

S7. Calculate returns of size indices:

Small-size index return from t−1 to t=Weight₁×Small value index return from t−1 to t+Weight₂×Small mixed index return from t−1 to t+Weight₃×Small growth index return from t−1 to t,calculate the medium-size and large-size indices in the similar manner Medium-size index return from t−1 to t=Weight₁×Medium value index return from t−1 to t+Weight₂×Medium mixed index return from t−1 to t+Weight₃×Medium growth index return from t−1 to t, and Large-size index return from t−1 to t=Weight₁×Large value index return from t−1 to t+Weight₂×Large mixed index return from t−1 to t+Weight₃×Large growth index return from t−1 to t;

S8. Calculate returns of value indices:

Value index return from t−1 to t=Weight₁×Small value index return from t−1 to t+Weight₂×Medium value index return from t−1 to t+Weight₃×Large value index return from t−1 to t, calculate the Mixed and Growth indices in the similar manner: Mixed index return from t−1 to t=Weight₁×Small mixed index return from t−1 to t+Weight₂×Medium mixed index return from t−1 to t+Weight₃×Large mixed index return from t−1 to t, and Growth index return from t−1 to t=Weight₁×Small growth index return from t−1 to t+Weight₂×Medium growth index return from t−1 to t+Weight₃×Large growth index return from t−1 to t; and

S9. Make parameter choices to construct size and value indices:

obtain the level of six indices at any given point of time following the steps in S6, which are small-size index, medium-size index, large-size index, value index, mixed index, and growth index, and calculate daily (cum)dividend return of each index as shown in S7 and S8.

One of the optimal choice solutions adopted by this patent is the X (percent) in S1. X is chosen from 10%, 20% and 30% in our setting.

Another optimal choice solution adopted by this patent is the optimal valuation ratio used in S3. The valuation ratio is chosen from the following:
1) Earning-to-price ratio, in which case, stocks' daily closing price and the most recent earning reported are obtained, and the last-day earning-to-price ratio is calculated, and then A-share stocks are sorted based on the last-month earning-to-price ratio into different categories;
2) Book-to-market ratio, in which case, stocks' quarterly book value and daily closing price are obtained, and the last-day book-to-market ratio is calculated as the ratio of the two, and then A-share stocks are sorted based on the last-month book-to-market ratio into different categories;
3) Cash-to-price ratio, in which case, stocks' quarterly cash flow per share and daily closing price are obtained, and the last-day cash-to-price ratio is calculated the ratio of the two, and then A-share stocks are sorted based on the last-month cash-to-price ratio into different categories; and
4) Sales-to-price ratio, in which case, stocks' quarterly sales and daily closing price are obtained, and the last-day sales-to-price ratio is calculated, and then A-share stocks are sorted based on the last-month sales-to-market ratio into different categories.

The third optimal choice solution adopted by this patent is the optimal weights on individual stocks in S5. There are three choices for stock i's weight:
1) Value weighted, i.e., stock i's market value at time t−1/the sum of all constituents' market values at time t−1;
2) Equal weighted, i.e., 1/count of constituents at time t−1; and
3) Alternative fundamental-indicator weighted, i.e., stock i's given fundamental indicator/the sum of all constituents' fundamental indicators in the corresponding index.

Another optimal choice solution adopted by this patent is the weights on individual stocks in S7 and S8. There are three choices for stock i's weight:
1) Value weighted, i.e., corresponding index's total market value at time t−1/the sum of three indices' market values at time t−1;
2) Equal weighted, i.e., ⅓; and
3) Alternative fundamental-indicator weighted, i.e., corresponding index's fundamental indicator/the sum of the fundamental indicators of the three indices.

The remaining of this section is a direct translation of the original application in Mandarin with China National Intellectual Property Administration.

Further, this invention provides a method for constructing size and value indices for China's stock market, comprising the following steps:

S1. obtaining the daily closing price and total number of shares of each China's A-share stock, calculating a product of the two to obtain the daily market value for each stock, and ranking all stocks based on the market values on the last trading day of a given month thereof, and deleting stocks which belong to the bottom X percent ranked by market value from the sample for the following month;

S2. based on the sample after the deletion, classifying A-share stocks according to the rank thereof by their market values at the end of the last month, with the stocks which belong to the bottom 0% to 33% defined as small-size stocks, stocks which belong to the bottom 34% to 66% defined as medium-size stocks, and stocks which belong to the bottom 67% to 100% defined as large-size stocks;

S3. based on the sample after the deletion, obtaining a valuation ratio of each of A-share stocks, classifying all stocks according to the rank by their last-month valuation ratios thereof, with the stocks which belong to the bottom 0% to 33% defined as value stocks, the stocks which belong to the bottom 34% to 66% defined as mixed stocks, and the stocks which belong to the bottom 67% to 100% defined as growth stocks;

S4. based on steps S2 and S3, classifying and grouping A-share stocks and obtaining nine size and value indices as follows:

| | | |
|---|---|---|
| small-size value | medium-size value | large-size value |
| small-size mixed | medium-size mixed | large-size mixed |
| small-size growth | medium-size growth | large-size growth |

S5. obtaining the closing price and dividend of each of the China's stocks on a given day, and for each of the indices, calculating the return over a period of time separately:

the return for the index from t−1 to t=Σstock i's weight*stock i's return from t−1 to t, wherein, stock i is the constituent stock of the index, and t is time, and
stock i's return from t−1 to t equals to the closing price of stock i at t plus the dividends of stock i within time t scaled by the closing price of stock i at t−1;

S6. for each of the indices, making an assumption that it has a benchmark value of 1000 at a certain point in time as the starting point, wherein for any point in time t, the total return of the index relative to the starting point in time may be calculated, and then the index values of the above nine indices at any point in time can be calculated: index value of an index at time t equals to 1000 multiplies the total return of the index from the starting point to the point t,

wherein, the total return of an index from the starting point to the point t equals to the product of the daily returns of the index from the starting point to the point t, and the method for calculating the return for the index is the same as is set forth in step S5;

S7. calculating returns of size indices:

Small-size company index's return from t−1 to t=Weight 1*Small-size value company index's return from t−1 to t+Weight 2*Small-size mixed company index's return from t−1 to t+Weight 3*Small-size growth company index's return from t−1 to t;
Wherein Weight 1, Weight 2 and Weight 3 are the weights on the small-size value index, on the small-size mixed index, and on the small-size growth index respectively, and Medium-size company index's return and Large-size company index's return may be calculated in the same manner;

S8. calculating returns of value indices:

Value company index's return from t−1 to t=Weight 1*Small-size value company index's return from t−1 to t+Weight 2*Medium-size value company index's return from t−1 to t+Weight 3*Large-size value company index's return from t−1 to t,
Wherein Weight 1, Weight 2 and Weight 3 are the weights on the small-size value, medium-size value, and large-size value indices, and Growth company index's return and Mixed company index's return may be calculated in the same manner; and

S9. constructing specific numeric values for the size and value indices using the same method as is in step S6. The index values of the following six indices at any time can be calculated: small-size company index, medium-size company index, large-size company index, value company index, mixed company index, and growth company index, and the method for calculating the daily return of each index is shown in step S7 and step S8.

As a preferred technical solution of the present invention, the X percent in step S1 is selected from 10%, 20%, and 30%.

As a preferred technical solution of the present invention, the valuation ratio in step S3 is selected from the following candidates:

(1) Earning-to-market value ratio, wherein quarterly earnings per share ratio and the closing price on any given day of each stock are obtained, and the Earning-to-market value ratio on the last day of each month is calculated as the ratio of the two, and A-share stocks are classified based on the last-month Earning-to-market value ratios thereof;
(2) Book-to-market ratio, wherein quarterly book value per share and the closing price on any given day of each stock are obtained, and the Book-to-market ratio on the last day of each month is calculated as the ratio of the two, and A-share stocks are classified based on the last-month Book-to-market ratios thereof;
(3) Cash-flow-to-price ratio, wherein quarterly cash per share and the closing price on any given day of each stock are obtained, and the cash-flow-to-price on the last day of each month is calculated as the ratio of the two, and A-share stocks are classified based on the last-month Cash-flow-to-price ratios thereof; and
(4) Sales-to-price ratio, wherein quarterly main business income per share and the closing price on any given day of each stock are obtained, and the sales-to-price ratio on the last day of each month is calculated as the ratio of the two, and A-share stocks are classified based on the last-month Sales-to-price ratio thereof.

As the preferred technical solution of the present invention, the weight of stock i in step S5 is selected from the following three options:

(1) a market value weight, defined as stock i's market value at t−1/the sum of market value at t−1 of all constituent stocks in the corresponding index;
(2) an equal weight, calculated as 1/the number of constituent stocks in a corresponding index at t−1; and
(3) a fundamental indicator weight, defined as stock i's given fundamental indicator at t−1/the sum of the fundamental indicators at t−1 of all constituent stocks in the corresponding index.

As a preferred technical solution of the present invention, the weights in steps S7 and S8 may have three options as follows:

(1) a market value weight, defined as the total market value of all constituent stocks at t−1 in the corresponding index divided by the total market value at t−1 of all constituent stocks in three indices;
(2) an equal weight, ⅓; and
(3) a fundamental indicator weight, defined as the sum of a given fundamental indicator of all constituent stocks at t−1 in a corresponding index/the sum of the given fundamental indicators at t−1 of all constituent stocks in three indices.

This invention categorizes A-share stocks into nine indices based on size and value, guiding different market participants who have different needs. Meanwhile, our methodology dynamically adjusts the sample used in the indices, deletes the stocks whose ranks drop below the cut-offs, and keeps the indices up-to-date.

### DETAILED DESCRIPTION

In the following, we use examples to illustrate our invention.

This invention proposes an innovative methodology to construct the size and value indices for China's A-share market. The procedures are as follows.

Follow step S1 to obtain individual stocks' daily closing price and A-share total shares outstanding in China's stock market, and take its daily product as the daily market value. Then in every month, sort the entire stock universe by their last trading day's market values, and delete the stocks that belong to the smallest X, and use the remaining stocks as the stock universe for the following month.

In particular, X can be selected among 10%, 20% and 30%, while our method suggests the optimal choice of 30% for X.

Follow step S2 to further separate the remaining sample from S1 equally by their last month-end market values into three size terciles, small-size group (bottom 33%), medium-size group (middle 33%) and large-size group (top 33%).

Follow step S3 to independently separate the remaining sample from equally by the inverses of their last month-end valuation ratios into three value terciles, value group (bottom 33%), mixed group (middle 33%), and growth group (top 33%).

Specifically, in S3, the valuation ratio candidates include:
1) Earning-to-price ratio, in which case, stocks' the most recent earning reported and daily closing price are obtained, and the last-day earning-to-price ratio is calculated as the ratio of the two, and then A-share stocks are sorted based on the last-month earning-to-price ratio into different categories;
2) Book-to-market ratio, in which case, stocks' quarterly book value and daily closing price are obtained, and the last-day book-to-market ratio is calculated, and then A-share stocks are sorted based on the last-month book-to-market ratio into different categories;
3) Cash-to-price ratio, in which case, stocks' quarterly cash flow per share and daily closing price are obtained, and the last-day cash-to-price ratio is calculated, and then A-share stocks are sorted based on the last-month cash-to-price ratio into different categories; and
4) Sales-to-price ratio, in which case, stocks' quarterly sales data and daily closing price are obtained, and the last-day sales-to-price ratio is calculated as the ratio of the two, and then A-share stocks are sorted based on the last-month sales-to-market ratio into different categories.

Our optimal choice solution uses 1)—earning-to-price ratio as the valuation ratio.

Follow step S4 to obtain nine A-share size and value indices as follows using the intersection of the groups from S2 and S3.

| | | |
|---|---|---|
| Small value | Medium value | Large value |
| Small mixed | Medium mixed | Large mixed |
| Small growth | Medium growth | Large growth |

And, follow step S5 to calculate individual stocks' cum-dividend returns using their closing prices and daily dividends. Then, the return of each of the nine indices is calculated as follows:

Ret(Index)_{t-1,t}=ΣWeightᵢ×Ret(stock i)_{t-1,t},

Where, Ret(Index)_{t-1,t} indicates the index return from t−1 to t, Weightᵢ indicates the weight of stock i in the index, Ret(stock i)_{t-1,t} indicates the cum-dividend return of stock i from t−1 to t, and t indicates the time point.

The cum-dividend return for stock i is calculated as:

$${Ret ( stock i )}_{t - 1 , t} = \frac{Close {Price}_{i , t} + {Dividend}_{i , t}}{Close {Price}_{i , t - 1}} ,$$

where Close Price_{i,t} and Close Price_{i,t-1} are the closing prices of stock i at time t and t−1, and Dividend_{i,t} is the dividends distributed from t−1 to t.

Specifically, in S5, the weight choice can be:
1) Value weighted, i.e., stock i's market value at time t−1/the sum of all constituents' market values at time t−1;
2) Equal weighted, i.e., 1/count of the constituents at time t−1 in the corresponding index; or
3) Alternative fundamental-indicator weighted, i.e., stock i's given fundamental indicator/the sum of all constituents' fundamental indicators in the corresponding index.

Follow step S6 to set the level of a chosen point of time as the benchmark level, and set the value of the benchmark level to be 1000. Then for any point of time, we can calculate the index level at this time point as Levelₜ=1000×Ret(Index)_{0,t}, where Ret(Index)_{0,t} is the cumulative return of this index from the starting point of the time to the time of t.

In particular, the cumulative return can be calculated as Π_{k=1, . . . t}Ret(stock i)_{k-1,k}, where Ret(stock i)_{k-1,k} is defined as in S5.

Follow step S7 to calculate returns of size indices:

Small-size index return from t−1 to t=Weight₁×Small value index return from t−1 to t+Weight₂×Small mixed index return from t−1 to t+Weight₃×Small growth index return from t−1 to t.

In similar manner, we can calculate the medium-size, and large-size indices: Medium-size index return from t−1 to t=Weight₁×Medium value index return from t−1 to t+Weight₂×Medium mixed index return from t−1 to t+Weight₃×Medium growth index return from t−1 to t, and Large-size index return from t−1 to t=Weight₁×Large value index return from t−1 to t+Weight₂×Large mixed index return from t−1 to t+Weight₃×Large growth index return from t−1 to t.

In Step 7, the optimal weight can be chosen from the following choices:
1) Value weighted, i.e., corresponding index's total market value at time t−1/the sum of three indices' market values at time t−1;
2) Equal weighted, i.e., ⅓; and
3) Alternative fundamental-indicator weighted, i.e., corresponding index's fundamental indicator/the sum of the fundamental indicators of the three indices.

Follow step S8 to calculate returns of value indices:

Value index return from t−1 to t=Weight₁×Small value index return from t−1 to t+Weight₂×Medium value index return from t−1 to t+Weight₃×Large value index return from t−1 to t.

In similar manner, we can calculate the Mixed, and Growth indices: Mixed index return from t−1 to t=Weight₁×Small mixed index return from t−1 to t+Weight₂×Medium mixed index return from t−1 to t+Weight₃×Large mixed index return from t−1 to t, and Growth-size index return from t−1 to t=Weight₁×Small growth index return from t−1 to t+Weight₂×Medium growth index return from t−1 to t+Weight₃×Large growth index return from t−1 to t.

In particular, similar to the weight choices in S7, the potential weight candidates in S8 are:
1) Value weighted, i.e., corresponding index's total market value at time t−1/the sum of three indices' market values at time t−1;
2) Equal weighted, i.e., ⅓; and
3) Alternative fundamental-indicator weighted, i.e., corresponding index's fundamental indicator/the sum of the fundamental indicators of the three indices.

Follow step S9 to choose specific parameters to construct size and value indices: obtain the level of six indices at any given point of time. The six indices are: small-size index, medium-size index, large-size index, value index, mixed index, and growth index. Daily (cum)dividend return for each index can be calculated as shown in S7 and S8.

What is described above is only a preferred example of the present invention, and does not therefore limit the patent scope of the present invention. All equivalent structural variations made utilizing the content of the description of the present invention or direct/indirect applications in other related technical fields under the inventive concept of the present invention are all embraced in the extent of patent protection of the present invention.

What is claimed is:

1. A method for constructing size and value indices of China's stock market, comprising the steps to:
S1. Obtain individual stocks' daily closing price and A-share total shares outstanding and take the product of the two as the daily market value, and in each month, sort the entire stock universe by individual stocks' market values on the last trading day, and then delete the stocks that belong to the smallest X (percent), and use the remaining sample as the stock universe for the following month;
S2. Further separate the remaining sample from S1 equally by their last month-end market values into three size terciles, small-size group (bottom 33%), medium-size group (middle 33%) and large-size group (top 33%);
S3. Independently separate the remaining sample from S1 equally by the inverses of their last month-end valuation ratios into three value terciles, value group (bottom 33%), mixed group (middle 33%), and growth group (top 33%);
S4. By using the intersection of the groups from S2 and S3, obtain nine A-share size and value indices as follows:

| | | |
|---|---|---|
| Small value | Medium value | Large value |
| Small mixed | Medium mixed | Large mixed |
| Small growth | Medium growth | Large growth |

S5. Calculate individual stocks' cum-dividend returns using their closing prices and daily dividends, and then, calculate the return of each of the nine indices as follows:
Ret(Index)_{t-1,t}=ΣWeightᵢ×Ret(stock i)_{t-1,t},
where, Ret(Index)_{t-1,t} indicates the index return from t−1 to t, Weightᵢ indicates the weight of stock i in the index, Ret(stock i)_{t-1,t} indicates the cum-dividend return of stock i from t−1 to t, and t indicates the time point,
the cum-dividend return for stock i being calculated as:
$${Ret ( stock i )}_{t - 1 , t} = \frac{Close {Price}_{i , t} + {Dividend}_{i , t}}{Close {Price}_{i , t - 1}} ,$$
where Close Price_{i,t} and Close Price_{i,t-1} are the closing prices of stock i at time t and t−1, and Dividend_{i,t} is the dividends distributed from t−1 to t;
S6. For each index, set the level at a chosen starting point as the benchmark level, and set the value of the benchmark level to be 1000, and then for any point in time t, calculate the index level at that time as Levelₜ=1000×Ret(Index)_{0,t}, where Ret(index)_{0,t} is the cumulative return of this index from the chosen starting point to the time of t,
in particular, the cumulative return being calculated as Π_{k=1, . . . t}Ret(stock i)_{k-1,k}, where Ret(stock i)_{k-1,k} is defined as in S5,
S7. Calculate returns of size indices:
Small-size index return from t−1 to t=Weight₁×Small value index return from t−1 to t+Weight₂×Small mixed index return from t−1 to t+Weight₃×Small growth index return from t−1 to t,
in similar manner, calculate the medium-size, and large-size indices: Medium-size index return from t−1 to t=Weight₁×Medium value index return from t−1 to t+Weight₂×Medium mixed index return from t−1 to t+Weight₃×Medium growth index return from t−1 to t, and Large-size index return from t−1 to t=Weight₁×Large value index return from t−1 to t+Weight₂×Large mixed index return from t−1 to t+Weight₃×Large growth index return from t−1 to t;
S8. Calculate returns of value indices:
Value index return from t−1 to t=Weight₁×Small value index return from t−1 to t+Weight₂×Medium value index return from t−1 to t+Weight₃×Large value index return from t−1 to t,
in similar manner, calculate the Mixed, and Growth indices: Mixed index return from t−1 to t=Weight₁×Small mixed index return from t−1 to t+Weight₂×Medium mixed index return from t−1 to t+Weight₃×Large mixed index return from t−1 to t, and Growth-size index return from t−1 to t=Weight₁×Small growth index return from t−1 to t+Weight₂×Medium growth index return from t−1 to t+Weight₃×Large growth index return from t−1 to t; and
S9. Make parameter choices to construct size and value indices:
by following the steps in S6, obtain the level of six indices at any given point of time, the six indices being small-size index, medium-size index, large-size index, value index, mixed index, and growth index, Daily (cum)dividend return of each index being calculated as shown in S7 and S8.

2. The method of claim 1, characterized in that X in step S1 is chosen from 10%, 20% and 30%.

3. The method of claim 1, characterized in that the valuation ratio in S3 is chosen from the following:
1) Earning-to-price ratio, in which case, stocks' the most recent earning reported and daily closing price are obtained, and the last-day earning-to-price ratio is calculated as the ratio of the two, wherein A-share stocks are sorted based on the last-month earning-to-price ratio into different categories;
2) Book-to-market ratio, in which case, stocks' quarterly book value and daily closing price are obtained, and the last-day book-to-market ratio is calculated as the ratio of the two, wherein A-share stocks are sorted based on the last-month book-to-market ratio into different categories;
3) Cash-to-price ratio, in which case, stocks' quarterly cash flow per share and daily closing price are obtained, and the last-day cash-to-price ratio is calculated as the ratio of the two, wherein A-share stocks are sorted based on the last-month cash-to-price ratio into different categories; and
4) Sales-to-price ratio, in which case, stocks' quarterly sales data and daily closing price are obtained, and the last-day sales-to-price ratio is calculated, wherein A-share share stocks are sorted based on the last-month sales-to-market ratio into different categories.

4. The method of claim 1, characterized in that the weight of stock i in step S5 has the following options:
1) Value weight, which is equal to stock i's market value at time t−1/the sum of all constituents' market values at time t−1;
2) Equal weight, which is equal to 1/count of constituents at time t−1; and
3) Alternative fundamental-indicator weight, which is equal to stock i's given fundamental indicator/the sum of all constituents' fundamental indicators in the corresponding index.

5. The method of claim 1, characterized in that the weight of stock i in steps S7 and S8 has the following options:
1) Value weight, which is equal to corresponding index's total market value at time t−1/the sum of three indices' market values at time t−1;
2) Equal weight, which is equal to ⅓; and
3) Alternative fundamental-indicator weight, which is equal to corresponding index's fundamental indicator/the sum of the fundamental indicators of the three indices.
